(19) United States
(12) Patent Application Publication
(10) Pub. No.: US 2005/0097066 A1
(43) Pub. Date: May 5, 2005

(54) Method and system for a mailing machine to verify the integrity of printed postage

(75) Inventor: Easwaran Nambudiri, Rye Brook, NY (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 10/698,150

(22) Filed: Oct. 31, 2003

(51) Int. Cl. G06F 17/60

(52) U.S. Cl. 705/401

(57) ABSTRACT

A mailing machine includes a transport mechanism for transporting mail pieces along a transport path. Also included in the mailing machine are a printing device for printing a postage indicia on the mail pieces transported by the transport mechanism, and a print control mechanism coupled to the printing device to control the printing device. The postage indicia includes a barcode. The mailing machine further includes a reading device located along the transport path to read the barcode. The mailing machine also includes a comparing mechanism coupled to the print control mechanism and the reading device to compare data read from the barcode by the reading device with data received by the comparing mechanism from the print control mechanism.

### BACKGROUND

This invention relates generally to the field of mailing machines, and more particularly to a mailing machine that has capabilities for detecting and responding to errors in printing postage indicia.

Generally, a mail piece transport on a mailing machine transports envelopes and other mail pieces along a transport path so that various functions may be performed on the mail piece at different locations along the transport path. For example, at one location along the transport path the mail piece may be weighed, at another location the mail piece may be sealed, and at a further location an indicia for postage may be applied to the mail piece. Drive rollers and/or drive belts may be employed to contact the mail piece to propel the mail piece along the transport path. The postage indicia may be applied by printing with a printing device on the mail piece. The printing device is associated with a postage security device (PSD) which holds postage funds and dispenses funds by causing the printing device to print the postage indicia. The PSD performs accounting functions to account for the dispensing of funds via the printing of postage indicia. The accounting functions include deducting funds from the amount of postage stored in the PSD in regard to each postage indicia printed by the printing device.

In accordance with some proposals, the postage indicia may contain a barcode or other machine-readable data to aid in verification of the validity of the postage indicia. One such postage indicia is defined in the Information-Based Indicia Program (IBIP) promulgated by the U.S. Postal Service.

Mailing machines are often run at high speed, and may handle batches consisting of thousands of mail pieces within a relatively short time. To the extent that operation of the mailing machine is attended by a human operator, often the operator's attention is concerned with feeding mail pieces into the mailing machine or with other tasks, and the operator may not have an opportunity to closely monitor the condition of mail pieces upon completion of processing of the mail pieces by the mailing machine. In particular, even if operation of the mailing machine is attended by a human operator, the operator may not be able to quickly and readily detect malfunctions of the postage meter printing device that may result in improper printing of postage indicia on mail pieces that are being processed by the mailing machine. Detection of improper printing may be of particular importance if the printing device is an ink jet printer, as has been proposed.

Failure of the printing device to properly print postage indicia may occur for a number of reasons. For example, improper printing or non-printing of indicia may occur due to one or more clogged ink nozzles or jets, or due to one or more ink jets being burned out, or because of a failure in the supply of ink to the print head. The printing device may also be subject to electronic failures.

Even a minor failure of the printing device may interfere with printing of the indicia barcode to an extent such that the indicia would fail a verification procedure that may be performed by postal authorities.

In at least some cases, occurrence of a failure in the printing device may not be known to the PSD. Consequently, the PSD may continue to direct the printing device to print indicia on mail pieces, as mail pieces are transported in sequence through the mailing machine, and may continue to deduct funds from the postage stored in the PSD, even at times when the printing device is failing to print a proper indicia on mail pieces transported past the printing device. This may have the effect of charging the proprietor of the mailing machine for postage even though the corresponding postage indicia were not effectively applied to the mail pieces. There may be no way for the proprietor of the mailing machine to recover the postage amounts which the PSD considered to have been dispensed, even though the postage was not applied to the mail pieces. Thus the failure or improper operation of the printing device may result in substantial financial loss to the proprietor of the mailing machine, particularly if large batches of mail are processed at high speed by a mailing machine in which the printing device has failed. Another problem that should be guarded against is the possibility that an unscrupulous mailer may tamper with the PSD and/or the printing device in a manner such that the PSD accounts for a first postage amount with respect to a mail piece even though the printing device prints an indicia on the mail piece that indicates payment of a postage amount that is higher than the first postage amount. It would be desirable to deter or detect such fraudulent operation of a postage metering device to prevent loss of funds on the part of the postal authorities.

### SUMMARY

Accordingly, an improved mailing machine is provided. An improved mailing machine includes a transport mechanism for transporting mail pieces along a transport path. The improved mailing machine also includes a printing device for printing a postage indicia on the mail pieces transported by the transport mechanism and a print control mechanism coupled to the printing device for controlling the printing device. The postage indicia includes a barcode. The improved mailing machine further includes a reading device located adjacent the transport path for reading the barcode, and a comparing mechanism coupled to the print control mechanism and to the reading device to compare data read from the barcode by the reading device with data received by the comparing mechanism from the print control mechanism.

The comparing mechanism may be coupled to the transport mechanism to halt operation of the transport mechanism if the data read by the reading device does not match the data received by the comparing mechanism from the print control mechanism.

In another aspect of the invention, a mailing machine includes a transport mechanism for transporting mail pieces along a transport path. The mailing machine also includes a printing device for printing a postage indicia on the mail pieces transported by the transport mechanism and a print control mechanism coupled to the printing device for controlling the printing and the printing process. The postage indicia includes a barcode. The mailing machine further includes a reading device located adjacent the transport path for reading the barcode, and a verification mechanism coupled to the reading device to receive data read from the barcode by the reading device and to perform a verification function with respect to the received data.

In still another aspect of the invention, a mailing machine includes a transport mechanism for transporting mail pieces along a transport path. The mailing machine also includes a printing device for printing a postage indicia on the mail pieces transported by the transport mechanism and a print control mechanism coupled to the printing device for controlling the printing and the printing process. The postage indicia includes a barcode and human-readable numerals that represent a postage amount. The mailing machine further includes a reading device located adjacent the transport path for reading the barcode and the human-readable numerals. The mailing machine also includes a comparing mechanism coupled to the reading mechanism to compare a postage amount represented by data read from the barcode with the postage amount represented by the human-readable numerals.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, description and claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a perspective view of a typical mailing machine constructed and arranged in accordance with the principles of the present invention.

FIG. 2 is a block diagram of aspects of the mailing machine of FIG. 1.

FIG. 3 is a specimen of a postage indicia of a type that may be printed by a printing device that is part of the mailing machine of FIGS. 1 and 2.

FIG. 4 is a flow chart that illustrates a process that may be performed by a system controller that is part of the mailing machine of FIGS. 1 and 2.

### DETAILED DESCRIPTION

A mailing machine provided in accordance with the invention includes a postage indicia reading capability to promptly detect errors or failures in the indicia printing device, so that operation of the mailing machine may be halted to prevent wasteful dispensing of postage funds by the PSD. In addition, or alternatively, the indicia reading capability may operate to detect and/or deter fraudulent operation of the mailing machine, such as accounting for a lower postage amount in the PSD than is actually printed on the mail piece.

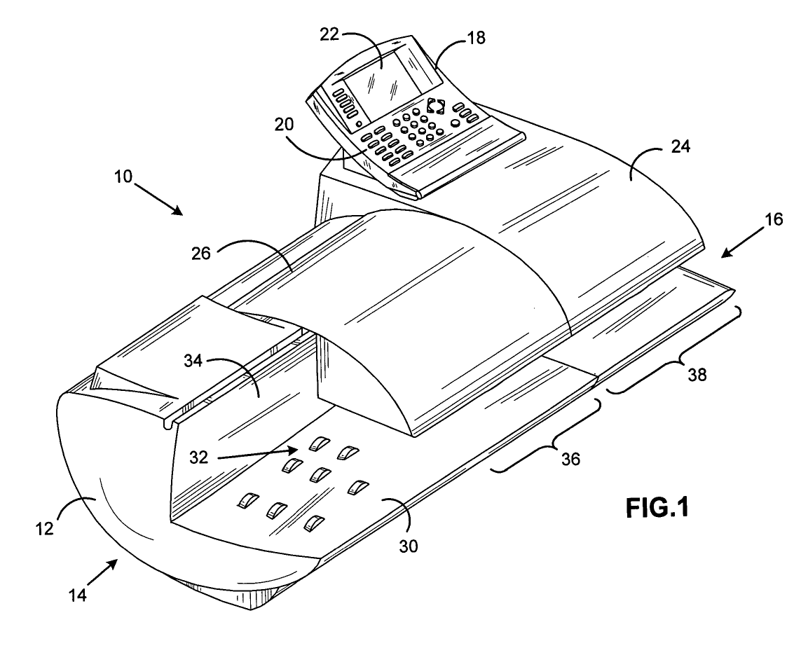

Referring now to the drawings, and particularly to FIG. 1, the reference numeral 10 indicates generally a typical mailing machine which incorporates the principles of the present invention. The mailing machine 10 includes a base unit generally designated by the reference numeral 12. The base unit 12 has an envelope infeed end, generally designated by the reference numeral 14, and an envelope outfeed end, designated generally by the reference numeral 16. A control unit 18 is mounted on the base unit 12, and includes one or more input/output devices, such as, for example, a keyboard 20 and a display device 22. A PSD (postage security device), which is not separately shown in FIG. 1, may be contained within the control unit 18.

Cover members 24, 26 are pivotally mounted on the base 12 and are moveable between a closed position shown in FIG. 1 and an open position (not shown). In the open position of the cover members 24, 26, various operating components and parts are exposed for service and/or repair as needed. A mail piece transport mechanism which is not visible in FIG. 1 is housed under the cover members 24, 26.

The base unit 12 further includes a generally horizontal feed deck 30 which extends substantially from the infeed end 14 to the outfeed end 16. A plurality of nudger rollers 32 are suitably mounted under the feed deck 30 and project upwardly through openings in the feed deck so that the rollers 32 can exert a forward feeding force on a succession of mail pieces placed in the infeed end 14. A vertical wall 34 defines a mail piece stacking location from which the mail pieces are fed by the nudger rollers 32 along the feed deck 30 and into the transport mechanism referred to above. The transport mechanism transports the mail pieces through one or more modules, such as, for example, a separator module and moistening/sealing module. Each of these modules is located generally in the area indicated by reference numeral 36. The mail pieces are then passed to a printing module located generally in the area indicated by reference numeral 38. An indicia reading module, to be discussed below, may be located in the area 38 downstream from the printing module.

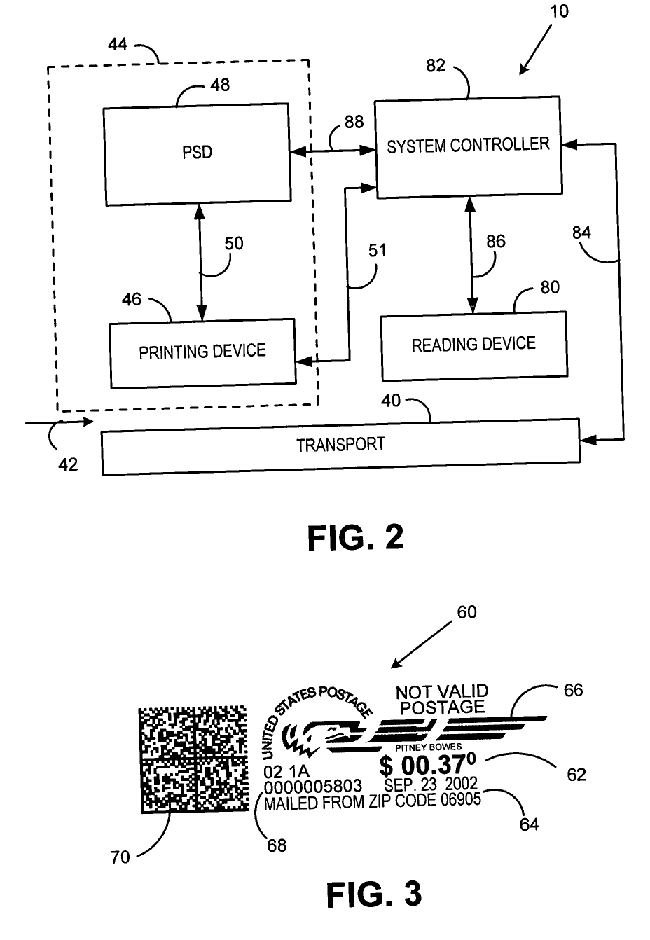

FIG. 2 is a block diagram representation of aspects of the mailing machine 10. As depicted in FIG. 2, the mailing machine 10 includes a transport mechanism 40, which may be constructed in accordance with conventional principles. For example, the transport mechanism 40 may include one or more drive belts, drive rollers and/or pressure rollers, which are not separately shown. The transport mechanism 40 transports mail pieces (not shown) along a transport path, which is indicated by arrow 42.

The mailing machine 10 also includes a postage meter 44 that includes a PSD (postage security device) 48 and a secure printing device 46 mounted on the mailing machine 10 adjacent the transport path 42. The printing device 46 is controlled by the system controller 82 for several printer related activities and the printing process of placing ink on mail pieces based on information received from the PSD 48. Thus, the printing device 46 prints a postage indicia on mail pieces transported along the transport path 42 by the transport mechanism 40. The PSD 48 can be coupled to the system controller 82 via signal path 88. Although the physical coupling of the PSD 48 to the printing device 46 is through the system controller 82, the PSD could be thought of as having a logical direct coupling to the printing device 46. Thus, the coupling of the PSD 48 to the printing device 46 may be via a data channel 50 or through channels 88 and 51. In accordance with conventional practices, the data channel(s) 50, 51 and 88 may be secured by encryption and/or decryption performed in the PSD 48 and/or the printing device 46. In some embodiments, all hardware aspects of the PSD 48 and the printing device 46 may be provided in accordance with conventional practices, and the PSD may also control the printing device 46 and may store and account for postage funds in accordance with conventional practices.

FIG. 3 is an illustration of a specimen postage indicia 60 of a type that may be printed by the postage meter 44. More specifically postage indicia 60 is a specimen of an indicia that may be printed on a mail piece by the printing device 46 under the control of the PSD 48.

Referring to FIG. 3, the indicia 60 may include conventional elements such as a postage amount 62 (in human-readable numerals), a postmark 64 (including date and location of mailing) and a manufacturer's icon, logo or trademark 66. The indicia 60 may further include a meter serial number 68 in the form of human-readable numerals. In addition, the indicia 60 may include an ascending register value (not shown) in the form of human-readable numerals.

The indicia 60 also includes a barcode 70 by which machine-readable data is presented. The data which may be included in the barcode 70, may include machine-readable versions of the meter serial number and the postmark information and/or destination information such as the destination zip code (e.g., an 11-digit zip code), as well as data that indicates the amount of postage represented by the indicia 60. The latter data should match the human-readable postage amount indication 62. The indicia may generally be in compliance with the “Information-Based Indicia Program” (IBIP) promulgated by the U.S. Postal Service. The IBIP information may contain high-density variable cryptographically protected information in a two-dimensional barcode. The IBIP information may be used for security and marketing purposes. In compliance with the IBIP, the barcode may be based on the well known PDF417 standard or Data Matrix standard.

Some or all of the constituent parts of the indicia 60 may reflect data transmitted from the PSD 48 to the printing device 46 via the data channel 50. The barcode 70, in particular, may represent data generated and/or stored by the PSD. The data as represented in the barcode 70 may be in encrypted form.

Referring again to FIG. 2, the mailing machine 10 also includes a reading device 80, which may be mounted on the mailing machine 10 adjacent the transport path 42 downstream from the printing device 46. In some embodiments, the reading device 80 may include a conventional barcode reader (not separately shown) that is suitable for reading the two-dimensional barcode 70 that is part of the indicia 60 printed by the postage meter 44. The reading device may also include optical character reading capabilities.

The mailing machine 10 also includes a system controller 82, which may include, for example, a conventional microprocessor or microcontroller, and which is coupled to the transport mechanism 40 via a signal path 84. For example, the system controller 82 may be coupled to receive user input signals from a user interface (not separately shown) which may be part of the control unit 18 (FIG. 1). In addition, the system controller 82 may control turning on and off of the transport mechanism 40. Various sensors and/or indicators, which are not shown, may also be coupled to the system controller 82.

In addition, the reading device 80 is also coupled to the system controller 82, via a signal path 86, to permit the reading device 80 to send a signal or signals to the system controller 82. For example, in some embodiments, the reading device 80 may send to the system controller 82 data acquired by the reading device 80 by reading the barcode 70 from a postage indicia 60 printed on a mail piece by the printing device 46.

In some embodiments, the system controller 82 is also coupled to the PSD 48 of the postage meter 44, via a signal path 88. The PSD 48 may send one or more signals to the system controller 82 via the signal path 88. For example, the PSD 48 may send to the system controller 82 data that is generated by the PSD 48 and/or used by the PSD 48 to drive the printing device 46 (via signal path or data channel 51) to print the postage indicia 60. In some embodiments, data generated by the PSD 48 to form at least part of the barcode 70 of the indicia 60 may be sent to the system controller 82 as well as to the printing device 46. The data for the barcode may be stored by the system controller 82 and may then be compared by the system controller 82 with corresponding data read by the reading device 80 from the barcode 70 printed on a mail piece by the printing device 46 based on the data sent from the PSD 48 to the printing device 46. Thus the reading device 80 may effectively allow the system controller 82 to “close the loop” by verifying proper printing of the postage indicia 60 (or at least a portion thereof) by the printing device 46 in accordance with the control data sent to the printing device 46 from the PSD 48.

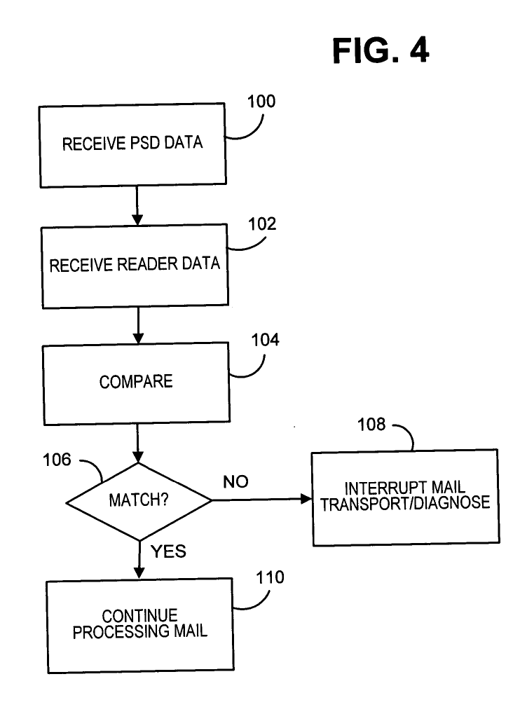

There will now be described, with reference to FIG. 4, a process performed by the system controller 82, according to some embodiments.

At step 100 in FIG. 4, the system controller 82 receives data from the PSD 48. The data received by the system controller 82 from the PSD 48 may include some or all of the data provided from the PSD 48 to drive the printing device 46 to print the indicia 60. For example, the data received by the system controller 82 from the PSD 48 may include some or all of the data to be presented by the barcode 70 of the indicia 60. The data received at step 100 may be encrypted in a form of encryption utilized in the barcode 70, or may be unencrypted.

Following step 100 is step 102. At step 102, the system controller 82 receives data from the reading device 80. The data received by the system controller 82 from the reading device 80 may include at least some data acquired by the reading device 80 by reading the postage indicia 60 that was printed based on data generated by the PSD 48 and sent to both the printing device 46 and to the system controller 82. (The data sent from the PSD 48 to the system controller 82 may be a subset of the data sent from the PSD 48 to the printing device 46.) For example, the data received by the system controller 82 from the reading device 80 may be at least part of data read from the barcode 70 by the reading device 80. The data received at step 102 may or may not be in encrypted form.

Step 104 follows step 102. At step 104, the system controller 82 compares at least some of the data received from the PSD 48 at step 100 with at least some of the data received from the reading device 80 at step 102. Step 102 may include comparing encrypted data to encrypted data and/or comparing unencrypted data to unencrypted data. The system controller 82 may function as necessary or appropriate to decrypt data received from the PSD at step 100 and/or to decrypt data received from the reading device 80 at step 102. The system controller 82 may also perform error correction processing on the data received from the reading device 80.

Following step 104 is a decision block 106, at which the system controller 82 determines whether at least some of the data received from the reading device 80 at step 102 matches at least some of the data received from the PSD 48 at step 100. The data read by the reading device 80, and the data received from the PSD 48 may include, for example, data representative of one or more alphanumeric values, including alphanumeric values represented by a portion of the barcode 70. The alphanumeric values may represent, for example, one or both of a postage amount and a date of mailing. If a negative determination is made at decision block 106 (i.e., if it is determined that the PSD data and reading device data do not match), then step 108 follows, and the system controller 82 halts operation of the transport mechanism 40 to interrupt processing of mail by the mailing machine 10. In conjunction with step 108, a warning indication may be provided to the human operator and/or various diagnostic or remedial processes may be initiated. For example, the PSD 48 could be operated to perform a self-diagnostic procedure, and/or a test indicia could be printed by the printing device 46 under control by the PSD 48 and then read by the reading device 80, and/or suitable operator intervention may occur, such as visual inspection of the printing device 46.

Referring again to decision block 106, if the PSD data and the reading device data are found to match, then step 110 follows, at which normal operation of the mailing machine 10 is allowed to continue.

In some embodiments, the operation of the system controller 82 to compare the PSD data and reading device data may be rapid enough to halt operation of the mailing machine, if appropriate, before the next indicia is printed. In other embodiments, halting of the mailing machine operation may not occur until one or more additional (and possibly defective) indicia have been printed. In some embodiments, printing of the next indicia waits or is suspended until the previous indicia has been read by the reading device 80 and determined by the system controller 82 to be proper. That is, in some embodiments, printing of a postage indicium does not occur until the immediately preceding indicium has been verified via the reading device 80.

In slower speed verification systems, not every mail piece will be read, but instead only a representative sample of mail pieces may be read. For example, every nth mail piece being processed, where n is an integer greater than one, could be read and verified, with the verification of the each mail piece being used to pass the following mail pieces until the next one is verified. If an indicium is not verified, then the operation of the mailing machine will be halted and the processing of mail pieces will be stopped. In some embodiments, the system checks of printing, reading and verification can be done only at startup of the mailing machine, and will not be repeated during the current operating cycle. In other embodiments, the system checks may be performed based on an operating time, such as, for example, every two minutes. Thus, the adaptive nature of the present invention allows for optimization of system performance and throughput to meet a variety of circumstances.

In some embodiments, the system controller 82 is programmed to verify the indicia 60 in the same fashion as a device operated by the postal authorities to perform mail acceptance and/or verification procedures. The verification performed by the system controller 82 in these embodiments may not require use of data from the PSD 48. If an indicia does not pass the verification procedure performed by the system controller 82, the system controller 82 may halt operation of the transport mechanism 40.

In further embodiments, mail processing by the mailing machine 10 may be halted if the reading device 80 indicates that it is unable to read the barcode.

In some embodiments, operation of the mailing machine 10 may be halted by the system controller 82 only if two or more indicia in a row fail to pass verification and/or fail to produce a match with data from the PSD and/or fail to have a feature to be detected by the reading device 80. It is noted that the postage meter 44 may be considered to be operating properly even if an occasional indicia is not verifiable. The Information-Based Indicia Program referred to above calls for a minimum indicia acceptance rate of 99.9%, so that an occasional defective indicia may be tolerable and need not alone occasion halting of the mailing machine.

In some embodiments, the reading device 80 may be operative to read human-readable numerals in the indicia 60 such as the postage amount 62. The system controller 82 may check to confirm that the human-readable postage amount 62 matches postage amount data included in barcode data read from the indicia by the reading device 80, and may halt operation of the mailing machine if there is no match.

With a mailing machine in accordance with the invention, including a reading device to allow detection of meter printing malfunctions, and automatic halting of mail processing when such malfunctions are detected, the proprietor of the mailing machine may be protected from loss of postage funds due to improper printing of indicia accompanied by automatic depletion of a postage meter fund balance. Furthermore, when the reading device and system controller operate to verify the indicia printed by the mailing machine, the proprietor of the mailing machine can have a reasonable degree of assurance that the mail processed by the mailing machine will be acceptable to the postal authorities. Moreover, in some cases, with suitable precautions such as spot checks, postal authorities may allow a reader/verification arrangement that is part of the mailing machine to take the place of and to make unnecessary a mail acceptance and verification procedure by the postal authorities at the post office. In addition, the indicia reading capability of the present invention can operate to detect and/or deter fraudulent operation of the mailing machine, such as accounting for a lower postage amount in the PSD than is actually printed on the mail piece.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

A number of embodiments of the present invention have been described. Nevertheless, it will be understood that various modifications may be made without departing from the spirit and scope of the invention. Accordingly, other embodiments are within the scope of the following claims.

1. A mailing machine comprising:
transport means for transporting mail pieces along a transport path;
printing means for printing a postage indicia on the mail pieces transported by the transport means, the postage indicia including a barcode;
print control means coupled to the printing means for controlling the printing means;
reading means, located adjacent the transport path, for reading the barcode; and
comparing means coupled to the print control means and to the reading means for comparing data read from the barcode by the reading means with data received by the comparing means from the print control means.

2. The mailing machine according to claim 1, wherein the comparing means is coupled to the transport means to halt operation of the transport means if the data read by the reading means does not match the data received by the comparing means from the print control means.

3. The mailing machine according to claim 1, wherein the reading means is operative to read at least one human-readable numeral from the postage indicia.

4. The mailing machine according to claim 3, wherein the comparing means is operative to compare data represented by the at least one human-readable numeral with data represented by the barcode.

5. A method of operating a mailing machine, the method comprising:
transporting mail pieces along a transport path;
printing a postage indicia on at least some of the mail pieces transported along the transport path, the postage indicia including a barcode;
reading the barcode by using a reader mounted on the mailing machine;
receiving data from a postage security device (PSD); and
comparing the data received from the PSD with data read from the barcode in the reading step.

6. The method according to claim 5, further comprising:
selectively halting the transporting of mail pieces in response to a result of the comparing step.

7. The method according to claim 6, wherein the transporting of the mail pieces is halted when the data read from the barcode does not match the data received from the PSD.

8. A mailing machine comprising:
transport means for transporting mail pieces along a transport path;
printing means for printing a postage indicia on the mail pieces transported by the transport means, the postage indicia including a barcode;
print control means coupled to the printing means for controlling the printing means;
reading means, located adjacent the transport path, for reading the barcode; and
verification means coupled to the reading means for receiving data read from the barcode by the reading means and for performing a verification function with respect to the received data.

9. The mailing machine according to claim 8, wherein the verification means is coupled to the transport means to halt operation of the transport means if the received data fails to satisfy the verification function.

10. The mailing machine according to claim 8, wherein the reading means is operative to read at least one human-readable numeral from the postage indicia, and the verification function includes comparing the received data with data indicated by the at least one human-readable numeral.

11. A method of operating a mailing machine, the method comprising:
transporting mail pieces along a transport path;
printing a postage indicia on at least some of the mail pieces transported along the transport path, the postage indicia including a barcode;
reading the barcode by using a reader mounted on the mailing machine; and
performing a verification function with respect to data read from the barcode in the reading step.

12. The method according to claim 11, further comprising:
selectively halting the transporting of mail pieces in response to a result of performing the verification function.

13. A mailing machine comprising:
transport means for transporting mail pieces along a transport path;
printing means for printing a postage indicia on the mail pieces transported by the transport means, the postage indicia including a barcode and human-readable numerals that represent a postage amount;
print control means coupled to the printing means for controlling the printing means;
reading means, located adjacent the transport path, for reading the barcode and the human-readable numerals; and
comparing means coupled to the reading means for comparing a postage amount represented by data read from the barcode with the postage amount represented by the human-readable numerals.

14. The mailing machine according to claim 13, wherein the comparing means is coupled to the transport means to halt operation of the transport means if the postage amount represented by the data read from the barcode does not match the postage amount represented by the human-readable numerals.

15. A method of operating a mailing machine, the method comprising:
transporting mail pieces along a transport path;
printing a postage indicia on at least some of the mail pieces transported along the transport path, the postage indicia including a barcode and human-readable numerals that represent a postage amount;
reading the barcode and the human-readable numerals by using a reader mounted on the mailing machine;
receiving data from a postage security device; and
comparing a postage amount represented by data read from the barcode with the postage amount represented by the human-readable numerals.

16. The method according to claim 15, further comprising:
selectively halting the transporting of mail pieces in response to a result of the comparing step.
